(19) United States
(12) Patent Application Publication
(10) Pub. No.: US 2005/0156573 A1
(43) Pub. Date: Jul. 21, 2005

(54) Circuit structure for rechargeable battery

(75) Inventor: Smart Lin, Sindian City (TW)

Correspondence Address: BRUCE H. TROXELL, SUITE 1404, 5205 LEESBURG PIKE, FALLS CHURCH, VA, 22041, US

(73) Assignee: Chin Hsen Technology Corp.

(21) Appl. No.: 10/745,602

(22) Filed: Dec. 29, 2003

(51) Int. Cl. H02J 7/00

(52) U.S. Cl. 320/134

(57) ABSTRACT

The improved circuit structure for a rechargeable battery has in a charging electric circuit device thereof for the battery with a detective protecting electric circuit and a charging-discharging electric circuit; the detective protecting electric circuit has a protective IC and a protective circuit switch; the charging-discharging electric circuit has a voltage stabilizing IC and a voltage stabilizing circuit switch connecting with the voltage stabilizing IC, the voltage stabilizing IC stabilizes the voltage of the battery at a set value, so that when the voltage of the battery is lower than the set value, the voltage stabilizing circuit switch is turned on. This assures normal activating of a unit such as a digital camera and prevents inactivation of the related devices of the camera (such as a driving motor of a lens of the camera) by activating a protective electric circuit in the circuit structure that can protect from overly charging or discharging.

### BACKGROUND OF THE INVENTION

1. Field of the Invention

The present invention is related to an improved circuit structure for a rechargeable battery, and especially to a circuit structure specifically suiting a lithium battery used on a portable electronic unit such as a digital camera, it can prevent the related devices (such as a lens of the digital camera) from inactivation by activating a protective electric circuit in the circuit structure that can protect from overly charging or discharging.

2. Description of the Prior Art

Most electronic units adapted for carrying on one's person available nowadays take rechargeable batteries as their power sources; such rechargeable batteries generally can be divided into nickel chromium batteries, nickel hydride batteries and lithium batteries. Wherein the metal chromium in the nickel chromium batteries is subjected to creating environmental pollution, the nickel hydride batteries are subjected to temperature influence, while the lithium batteries are widely used in various portable electronic units because of their high density and long life of use.

However, the output voltage in using a lithium battery is higher (circa 3.6 volts), a load may be damaged by overly high voltage in using a lithium battery as a power source. Therefore, a rechargeable battery unit that can perform output voltage control must be used.

FIG. 1 shows a conventional rechargeable battery unit that can prevent overly charging and discharging. The unit mainly is provided with a detective protecting electric circuit 11 parallelly connected with two batteries 10 in parallel connection mutually, the positive and the negative electrodes of the batteries 10 are electrically connected with the electric conductive portion of a lithium battery to further connect with a load 12, thereby the batteries 10 can get their object of electric power supplying. The load 12 can also be substituted by a charger that cooperates with a charging circuit 13 to charge the batteries 10.

In the above circuit structure, for the purpose of preventing overly charging and discharging, the detective protecting electric circuit 11 is provided with a circuit switch 14 having a protective IC, the circuit switch 14 mainly has therein two field effect transistors (MOSFET) 15, 16, its principle of operation is: when in overly charging, i.e., it is detected that the voltage of the batteries 10 exceeds the set value (such as 4.25 volts), one field effect transistor 15 is turned on, while the other field effect transistor 16 is cut off, hence the charger stop charging the batteries 10. When the lithium battery connecting with the load 12 and it overly discharges, and it is detected that the voltage of the batteries 10 is lower than a set value (such as 2.3 volts), the field effect transistor 15 is cut off, while the other field effect transistor 16 is turned on, the batteries 10 immediately stop supplying power, thereby the function of protection from overly discharging can be achieved.

However, when the above stated rechargeable battery unit is used in related components (such as a driving motor for a lens of a digital camera) of a portable electronic unit (such as the digital camera), some disadvantage may be induced. As shown in FIG. 2, when the above stated circuit structure is used in a driving motor 17 of a lens of a digital camera, the voltage of the batteries 10 is lower than a set value, the above stated circuit will render the batteries 10 to stop supplying power, and a trouble that the digital camera having been opened is unable to close can be induced.

### SUMMARY OF THE INVENTION

The main object of the present invention is to provide an improved circuit structure for a rechargeable battery, the structure specifically suits a portable electronic unit such as a digital camera, it can prevent the related devices from inactivation by activating a protective electric circuit in the circuit structure that can protect from overly charging or discharging.

To obtain the object, the present invention is provided in a charging electric circuit device thereof for the battery with a detective protecting electric circuit and a charging-discharging electric circuit; the detective protecting electric circuit has a protective IC and a protective circuit switch; the charging-discharging electric circuit has a voltage stabilizing IC and a voltage stabilizing circuit switch connecting with the voltage stabilizing IC, the voltage stabilizing IC stabilizes the voltage of the battery at a set value, so that when the voltage of the battery is lower than the set value, the voltage stabilizing circuit switch can be electrically turned on to make maximum outputting of the battery to drive the related components of a portable electronic unit.

The present invention will be apparent in its novelty and features after reading the detailed description of the preferred embodiment thereof in reference to the accompanying drawings.

### BRIEF DESCRIPTION OF THE DRAWINGS

FIG. 1 is a circuit diagram showing the structure of a conventional rechargeable battery able to prevent overly charging and discharging;

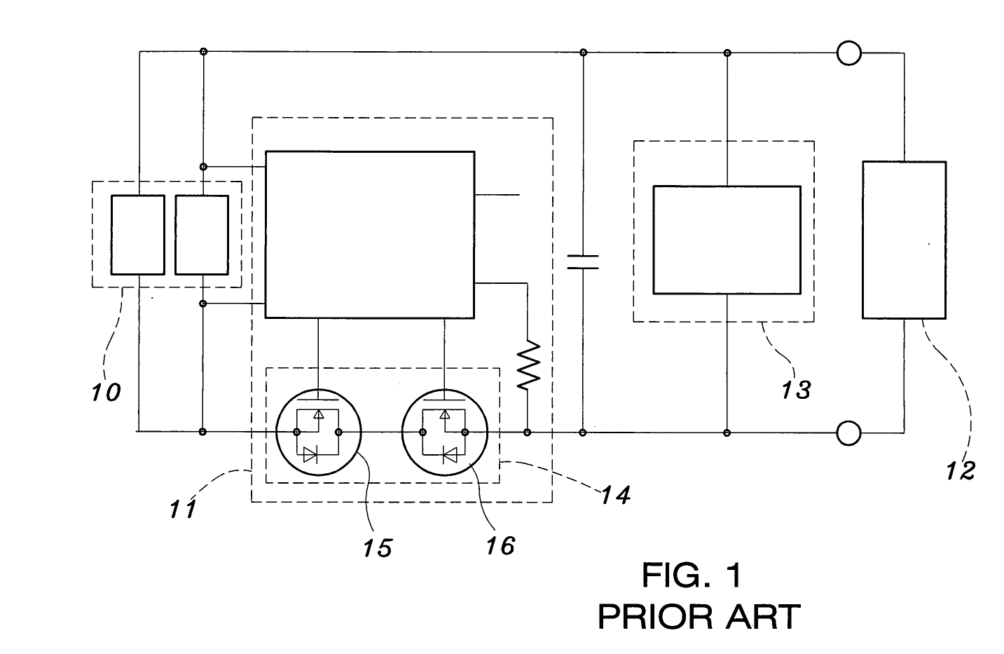

FIG. 2 is a circuit diagram of a driving motor for a lens of a digital camera in FIG. 1;

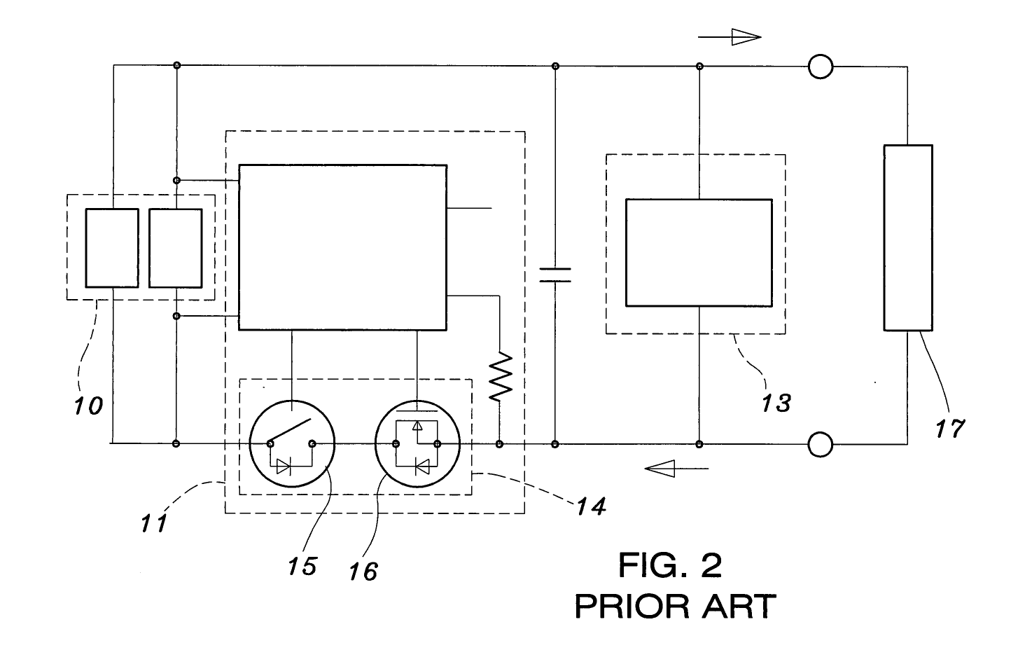

FIG. 3 is a circuit diagram of a preferred practicable embodiment of the present invention;

FIG. 4 is a schematic view showing that FIG. 3 is connected to a charger;

FIG. 5 is a schematic view showing that FIG. 3 is connected to a load; and

FIG. 6 is a circuit diagram showing that the present invention is connected to a driving motor for a lens of a digital camera.

### DETAILED DESCRIPTION OF THE PREFERRED EMBODIMENT

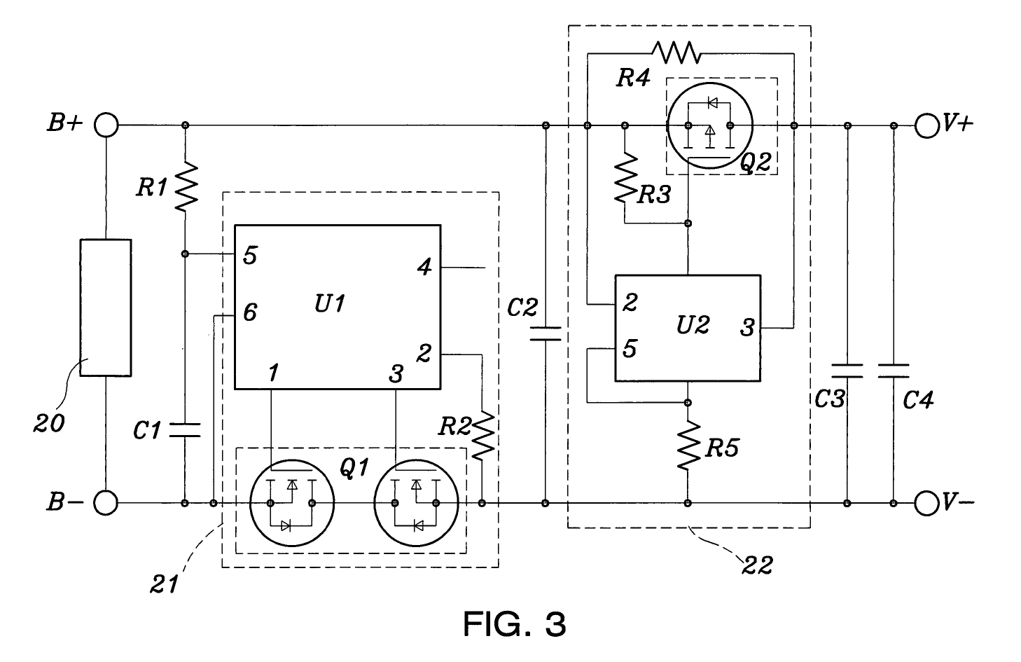

Referring to FIG. 3, in the preferred practicable embodiment, the present invention is provided in a charging electric circuit device thereof for a battery 20 with a detective protecting electric circuit 21 and a charging-discharging electric circuit 22. The detective protecting electric circuit has 21 a protective integrated circuit (IC) U1 and a protective circuit switch Q1; the charging-discharging electric circuit 22 has a voltage stabilizing integrated circuit (IC) U2 and a voltage stabilizing circuit switch Q2 connecting with the voltage stabilizing integrated circuit (IC) U2. The voltage stabilizing integrated circuit (IC) U2 stabilizes the voltage of the battery 20 at a set value (such as 3.0 volts).

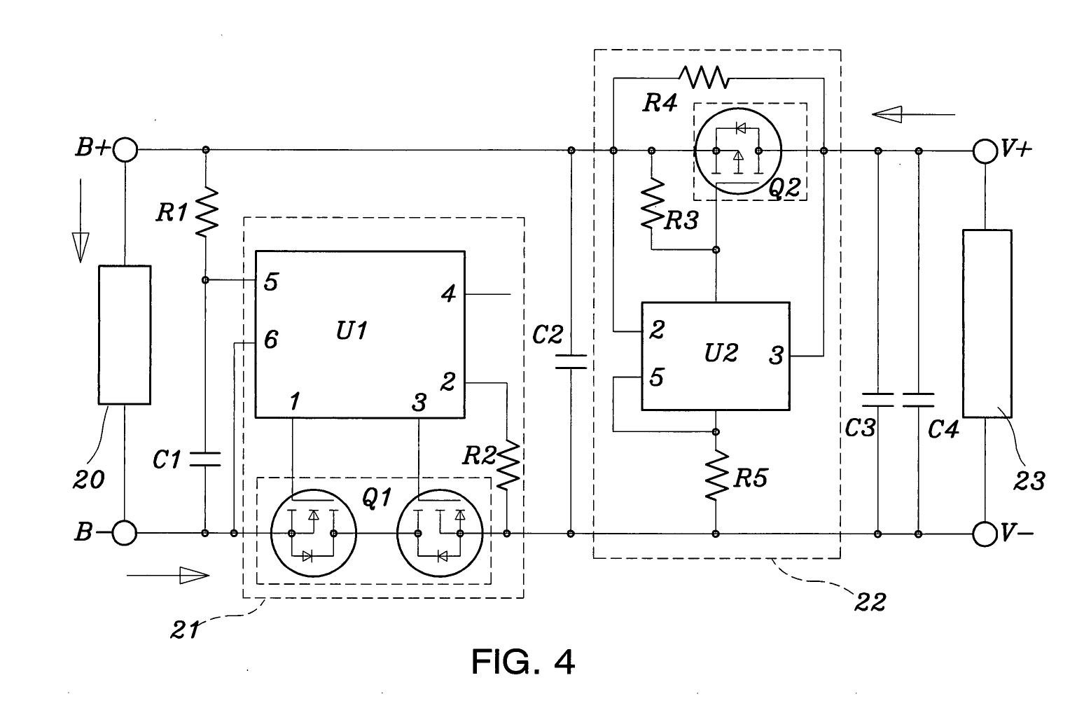

As shown in FIG. 4, when the circuit structure of the present invention uses a charger 23 for electric charging, the protective integrated circuit (IC) U1 detects at B+ and B−, when the voltage of the battery 20 exceeds the set value (such as 4.25 volts), the protective circuit switch Q1 is cut off, this can prevent the charger 23 from overly charging the battery 20.

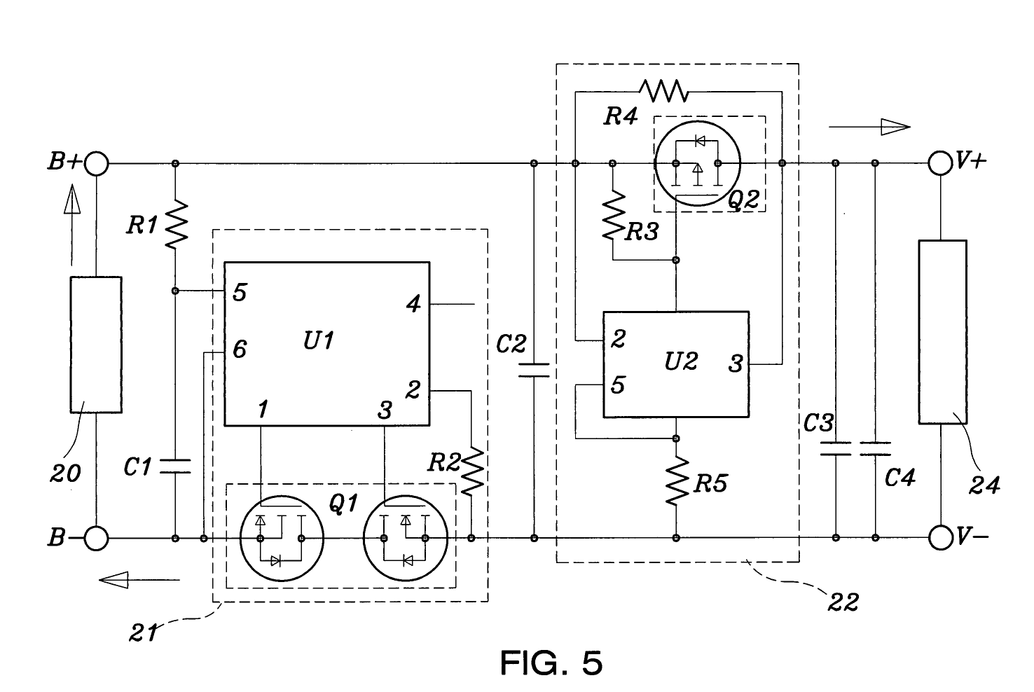

As shown in FIG. 5, when the circuit structure of the present invention is connected to a load 24 for discharging or making short circuit, the protective integrated circuit (IC) U1 similarly detects at B+ and B−, when the voltage of the battery 20 is lower than the set value (such as 2.25 volts), the protective circuit switch Q1 is cut off, this can prevent overly discharging of the battery 20.

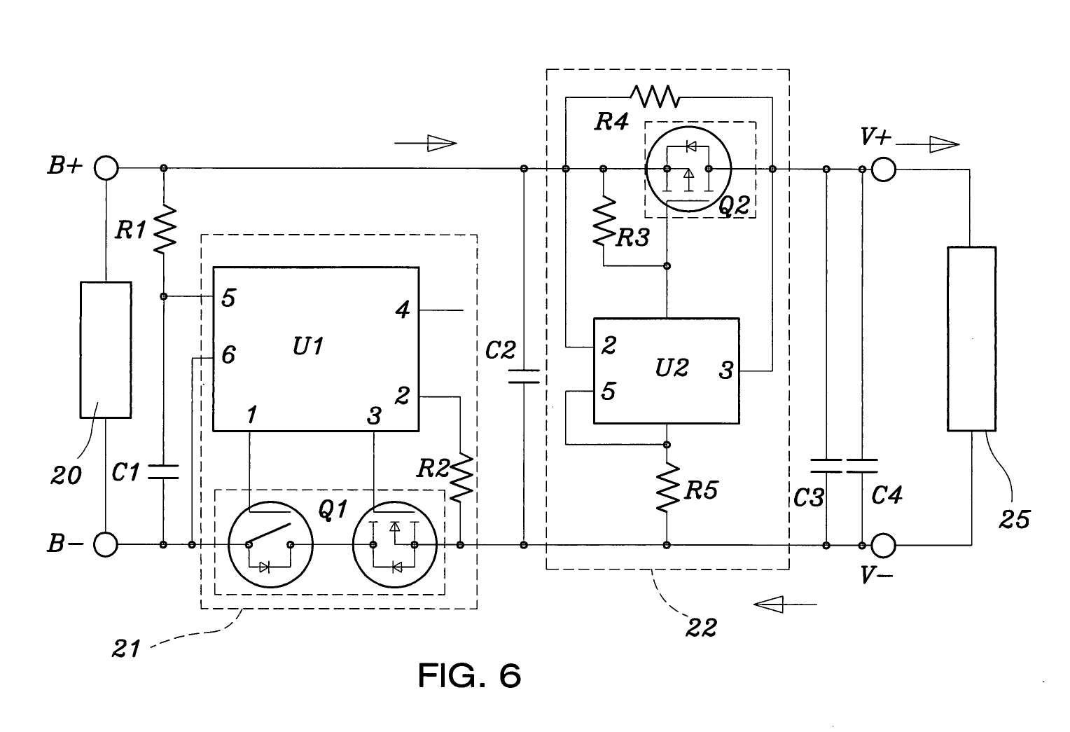

And as shown in FIG. 6, when the battery 20 of the present invention discharges as above, the other voltage stabilizing circuit switch Q2 is cut off, while the voltage stabilizing integrated circuit (IC) U2 stabilizes the voltage of the battery 20 at a set value (such as 3.0 volts). This improved structure thereby can turn on the voltage stabilizing circuit switch Q2 when it is used in related components (such as a driving motor 25 of a lens of a digital camera as shown) of a portable electronic unit and the voltage of the battery 20 is lower than the set value (3.0 volts) during discharging, this can make maximum outputting of the battery 20 to drive the related components (such as the driving motor 25 of the lens of the digital camera as shown) of the portable electronic unit.

Taking the above stated driving motor 25 of the lens of the digital camera as an example, the digital camera having been opened and being unable to close as the conventional case mentioned above can be smoothly retracted and closed.

The above stated structure of the present invention can stabilize voltage to prevent the situation of being unable to activate the camera, being non operable or even damaging the circuit of the camera in the circuit structure that can protect from overly charging or discharging, and can further prevent the related devices of an electronic unit from inactivation by activating a protective electric circuit, thereby the trouble that the related devices of the electronic unit is non operable by activating the protective electric circuit can be gotten rid of.

The embodiment given is only for illustrating the present invention and not for giving any limitation to the scope of the present invention. It will be apparent to those skilled in this art that various modifications or changes without departing from the spirit of this invention shall also fall within the scope of the appended claims.

1. An improved circuit structure for a rechargeable battery, said circuit structure is provided in a charging electric circuit device thereof for said battery with a detective protecting electric circuit and a charging-discharging electric circuit; said detective protecting electric circuit has a protective IC and a protective circuit switch; said charging-discharging electric circuit has a voltage stabilizing IC and a voltage stabilizing circuit switch connecting with said voltage stabilizing IC, said voltage stabilizing IC stabilizes voltage of said battery at a set value, so that when said voltage of said battery is lower than said set value, said voltage stabilizing circuit switch is electrically turned on.

2. The improved circuit structure for a rechargeable battery as claimed in claim 1, wherein said voltage stabilizing IC stabilizes voltage of said battery at a set value 3.0 volts.

3. The improved circuit structure for a rechargeable battery as claimed in claim 1, wherein said circuit structure is connected to a load for making discharging of said battery.

4. The improved circuit structure for a rechargeable battery as claimed in claim 3, wherein said load is a component of a portable electronic unit.

5. The improved circuit structure for a rechargeable battery as claimed in claim 3, wherein said load is a driving motor for a lens of a digital camera.
